(19) United States
(12) Patent Application Publication
(10) Pub. No.: US 2007/0271176 A1
(43) Pub. Date: Nov. 22, 2007

(54) Method for providing financing for rental housing

(76) Inventor: Mark H. Ebner, Columbus, OH (US)

Correspondence Address: Patrick P. Phillips;KREMBLAS, FOSTER, PHILLIPS & POLLICK, 7632 Slate Ridge Blvd, Reynoldsburg, OH, 43068, US

(21) Appl. No.: 11/436,438

(22) Filed: May 19, 2006

(51) Int. Cl. G06Q 40/00

(52) U.S. Cl. 705/38

(57) ABSTRACT

A method for financing rental housing is provided having the steps of having the lessor obtain information from a potential renter or existing renter on income, expenses, and debt; having the lessor conduct a preliminary evaluation on whether the person might be able to obtain a line of credit; having the lessor notify the potential renter or renter that there is a possibility of the potential renter or renter obtaining a line of credit; submitting a line of credit application to at least one finance company; notifying the potential renter or renter of the decision of each finance company; having each finance company select an interest rate and credit limit if the potential renter or renter is able to obtain a line of credit from the finance company; having the potential renter or renter select a finance company; and finalization by the person of the obtaining of a line of credit. Upon finalization by the person of obtaining a line of credit, one embodiment has the person pay an annual fee. In one embodiment, the line of credit is transferable.

### BACKGROUND OF THE INVENTION

1. Field of the Invention

This invention relates generally to rental housing, and more particularly, to a method for providing renters with financing for such housing.

2. Description of the Related Art

This invention is directed to a method for providing financing for those who live in rental housing. A significant number of persons (i.e. individuals as well as families) do not own their own home. One study estimated that 40,000,000 people in the United States are renters of residential property. For these individuals, housing is often obtained in the form of a rental property, whether it is in the form of a house or an apartment.

For many renters, their rent payment often is in the form of cash or a check/money order. However, some rental management companies permit rent to be paid by credit/debit card or direct withdrawal from the renter's banking account. However, some individuals do not have a cash flow that consistently enables them to pay by cash, check or direct withdrawal. Then there are others who do not have a credit history that enables them to have a credit card, or at least a credit card that charges them a relatively manageable rate of interest, which serves as an additional deterrent to wanting to use such a credit card as a means to pay the rent. There are also some individuals who do not want a credit card because having one causes them to indiscriminate spending habits.

If an individual is lucky enough to be a home owner, in the event that an unforeseen financial situation occurs, even if the individual does not have savings adequate to address the situation, the individual may qualify for a home equity loan. Thus, for some individuals, there is a way to access funds needed to make their monthly housing payment other than by resorting to use of a credit card. Unfortunately, this option does not exist for those who rent.

Consequently, sometimes situations arise which cause renters with a good credit history to fall behind in their payments of rent. These situations may be unforeseen, or the result of a change in lifecycle. With respect to the landlord/management company, this can cause a cashflow problem, since anticipated rent is not being paid. With respect to the tenant, if left unremedied this situation can result in the tenant being evicted, with no relatively convenient reasonable cost alternative. While this may seem like a logical resolution to the problem, the vacancy of the rental unit incurs additional costs to the landlord/management company in preparing the rental unit for the next tenant in addition to causing a lack of cash flow.

Thus, it would be desirable to provide a way for tenants to have access to funds that can cover their rent in the event of a shortage of funds, while at the same time providing an assurance of rent payment even when the tenant encounters what may only be a short-term financial problem. It is thus apparent that the need exists for a method for providing financing for rental housing.

### SUMMARY OF THE INVENTION

In accordance with the present invention, there is disclosed a method for financing rental housing having the steps of having the lessor obtain information from a potential renter or existing tenant on income, expenses, and debt; having the lessor conduct a preliminary evaluation on whether the potential renter might be able to obtain a line of credit; having the lessor notify the potential renter that there is a possibility of the potential renter obtaining a line of credit; submitting a line of credit application to at least one finance company; notifying the potential renter of the decision of each finance company; having each finance company select an interest rate and credit limit if the potential renter is able to obtain a line of credit from the finance company; having the potential renter select a finance company; and finalization by the renter of the obtaining of a line of credit.

The preliminary evaluation utilizes predetermined income/expense ratios selected by the lessor and/or the potential lender. The method also preferably includes the step of having the lessor obtain an initial fee to cover the processing of the application by a finance company for a line of credit for the potential renter.

In one embodiment of the invention, the finalization by the renter of obtaining a line of credit includes paying an annual fee. In another embodiment of the invention, the method includes the step of increasing the interest rate owed to the selected finance company in lieu of payment of the annual fee for the line of credit. Preferably the method includes the step of the potential renter becoming a renter.

Preferably the method also includes the step of the renter using the line of credit. One embodiment of the method includes the step of the renter paying an access service fee when the line of credit is used. One aspect of the method includes the line of credit being transferable at any accepting rental location. However, this transferability does not extend to having the line of credit being transferable between persons.

The primary objective of this invention is to provide a method for financing rental housing that is advantageous to both tenants and landlords/management companies.

Another objective of this invention is to provide a method for financing rental housing that is flexible enough to be used in various locales and by various types of landlords/management companies.

Still another objective of this invention is to provide a method for financing rental housing that is transferable when the tenant moves to another property of the landlord/management company or potentially transferable when the tenant moves to a property of another landlord/management company.

Other objects and advantages of the invention will be apparent from the following description, the accompanying drawings and the appended claims.

### BRIEF DESCRIPTION OF THE DRAWINGS

FIG. 1 is a flow diagram of a method for financing rental housing utilizing this invention.

FIG. 2 is a flow diagram of a modified method that utilizes this invention.

In describing the embodiments of the invention which are illustrated in the drawing, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described method, and any further applications of the principles of the invention as described herein are contemplated as would normally occur to one skilled in the art to which the invention relates.

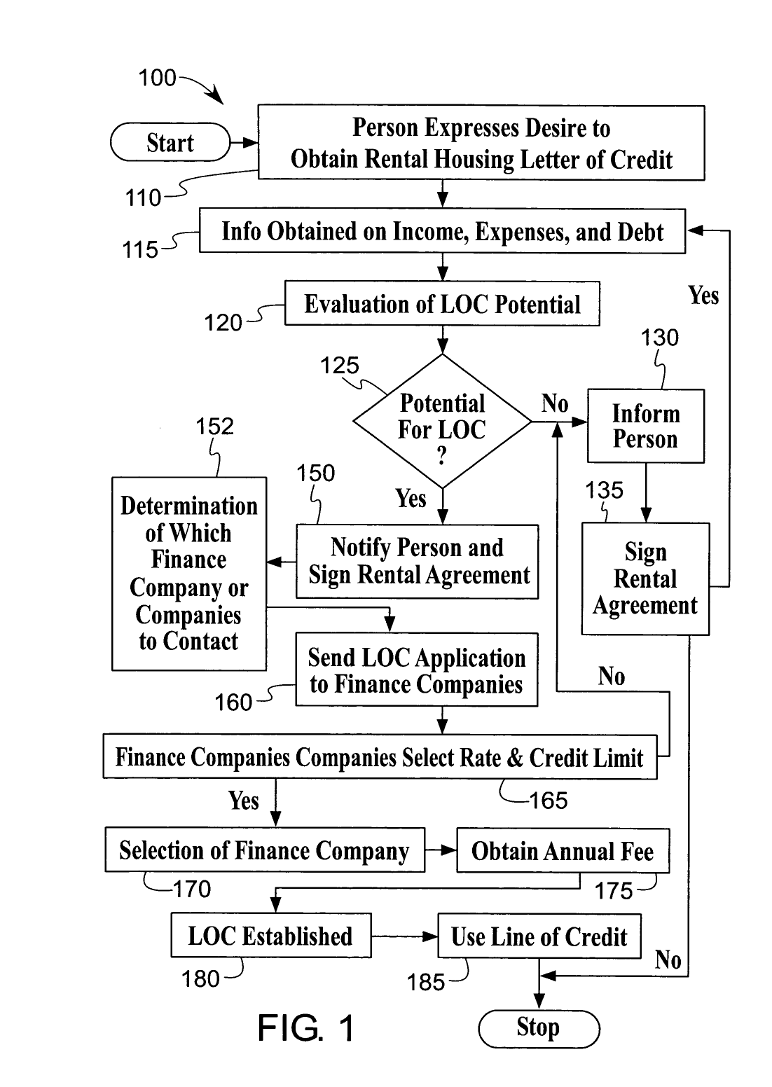

Having reference to the drawing, attention is directed to FIG. 1, which discloses a flow diagram for a method of financing rental housing in accordance with the preferred embodiment of the invention designated generally by the numeral 100. It should be appreciated that the method begins with stage 110, at which stage a person expresses a desire to rent from a lessor or, if already a tenant, expresses a desire to be considered for a letter of credit as a method of providing financing for rental housing. This person for purposes of the invention can be an individual, a couple, or group of individuals.

The next stage 115 has the lessor obtaining information from the person, with this information including the person's income, expenses, and debt. Subsequently, in stage 120 the lessor compares the aforesaid information with predetermined ratios that the lessor has decided to use in connection with the lessor's preliminary evaluation of the likelihood that a person will be successfully able to obtain a line of credit. The predetermined ratios can vary depending on factors including but not limited to the geographical location, the number of individuals to inhabit the residence, the fixed and variable costs to be borne by the lessor, the credit worthiness of the borrower, the time of year, and the current vacancy rates of the lessor. Upon concluding the evaluation, at stage 125 the lessor determines whether the potential renter or renter is a candidate for a line of credit from a finance company.

Assuming the lessor determines the income versus expense ratio and the current debt level of the potential renter or renter is such that the person will clearly not be able to obtain a line of credit, at stage 130 the lessor so informs the person. Assuming the lessor still desires to rent to the person, and the renter still desires to pursue renting of the residence, at stage 135 the two parties sign a rental agreement.

Subsequent to that time, the person's financial circumstances may change, such that as shown in FIG. 1 by the line notated with a “yes” the person can go to the lessor at stage 115 to provide information on income, expenses, and debt. Otherwise, utilization of the method of this invention is over as shown by the line descending from stage 135 and notated with a “no”.

On the other hand, if the lessor determines that the person may be able to obtain a line of credit, at stage 150 the lessor so notifies them and the two parties sign the rental agreement if the person is a potential renter. At stage 152, the lessor then determines which finance companies to contact. This determination is accomplished in part by comparing the ratios and other financial information obtained in stage 115 with the issuing requirements associated with lines of credit from some of the finance companies known to the lessor.

Having determined which finance company or companies to contact for the person sends at stage 160 at least one application for a line of credit to one or more of the finance companies selected at stage 152. The finance company or companies contacted at stage 160, upon consideration of the application then determine at stage 165 whether a line of credit can be issued, and if so, the interest rate and credit limit associated with the line of credit.

If the determination at stage 165 results in denial of a line of credit, as shown in FIG. 1 with the line notated with a “no”, the person is so informed at stage 130. Conversely, if the determination results in at least one finance company being willing to extend a line of credit, then at stage 170 the specific finance company is selected. This selection can be by just the lessor, or the lessor can involve the person in the selection process.

Thereafter in this embodiment of the invention, at stage 175 an annual fee is obtained in connection with the establishment at stage 180 of a line of credit between a finance company and the renter. The amount of this annual fee would be the prevailing annual fee charged by the finance company to other customers who have lines of credit. Should the renter need money to assist with payment of rent, the line of credit can be utilized at stage 185.

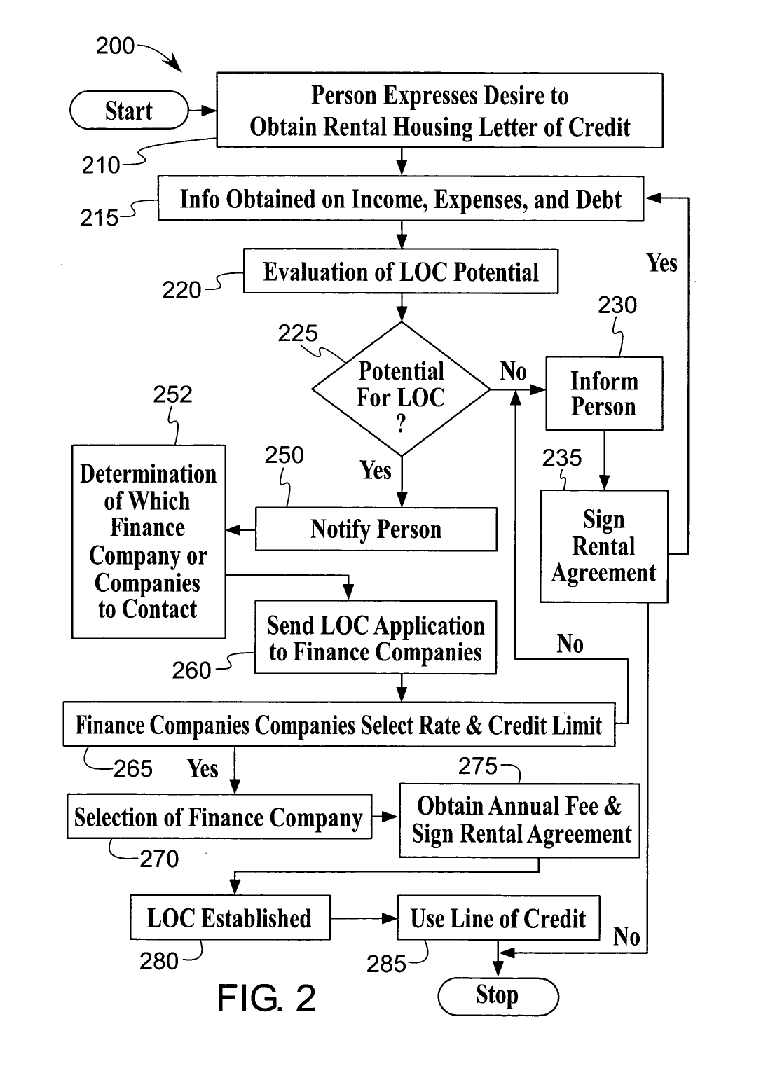

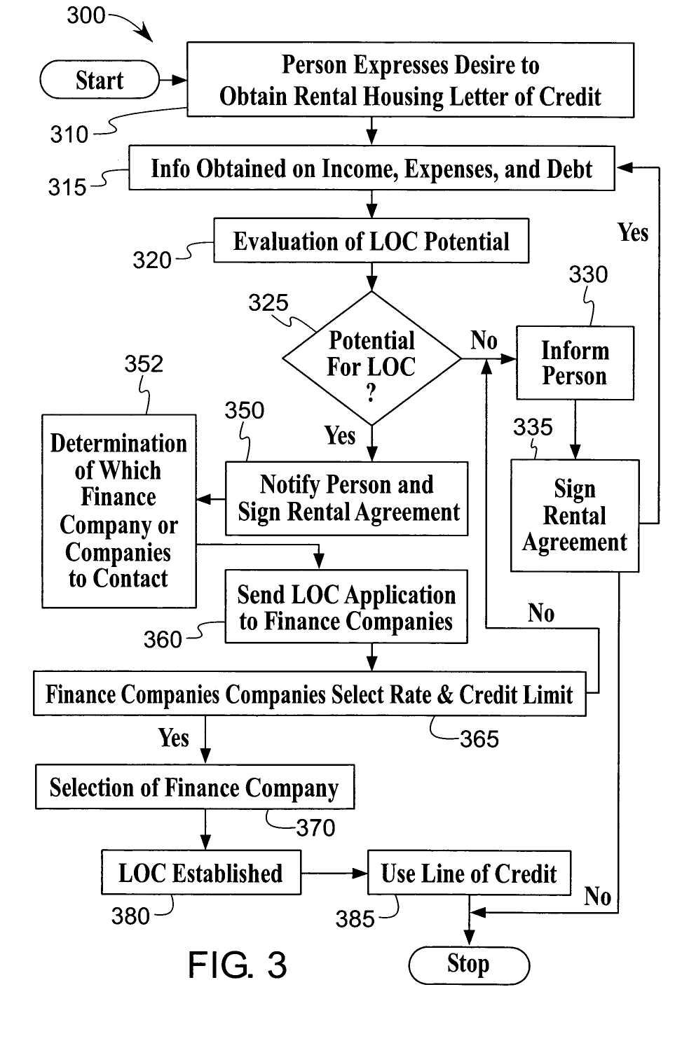

A modified embodiment of the invention is disclosed in FIG. 2, which discloses a flow diagram for a method of financing rental housing in accordance with another embodiment of the invention designated generally by the numeral 200. It should be appreciated that the method begins with stage 210, at which stage a person expresses a desire to rent from a lessor or, if already a tenant, expresses a desire to be considered for a letter of credit as a method of providing financing for rental housing. This person for purposes of the invention can be an individual, a couple, or group of individuals.

The next stage 215 has the lessor obtaining information from the person, with this information including the person's income, expenses, and debt. Subsequently, in stage 220 the lessor compares the aforesaid information with predetermined ratios that the lessor has decided to use in connection with the lessor's preliminary evaluation of the likelihood that a person will be successfully able to obtain a line of credit. The predetermined ratios can vary depending on factors including but not limited to the geographical location, the number of individuals to inhabit the residence, fixed and variable costs to be borne by the lessor, time of year, and current vacancy rates of the lessor. Upon concluding the evaluation, at stage 225 the lessor determines whether the potential renter or renter is a candidate for a line of credit from a finance company.

Assuming the lessor determines the income versus expense ratio and the current debt level of the potential renter or renter is such that the person will clearly not be able to obtain a line of credit, at stage 230 the lessor so informs the person. Assuming the lessor still desires to rent to the person, and the renter still desires to pursue renting of the residence, at stage 235 the two parties sign a rental agreement.

Subsequent to that time, the person's financial circumstances may change, such that as shown in FIG. 2 by the line notated with a “yes” the person can go to the lessor at stage 215 to provide information on income, expenses, and debt. Otherwise, utilization of the method of this invention is over as shown by the line descending from stage 235 and notated with a “no”.

On the other hand, if the lessor determines that the person may be able to obtain a line of credit, at stage 250 the lessor so notifies the person. At stage 252, the lessor then determines which finance companies to contact. This determination is accomplished in part by comparing the ratios and other financial information obtained in stage 215 with the issuing requirements associated with lines of credit from some of the finance companies known to the lessor.

Having determined which finance company or companies to contact, the lessor obtains from the person an initial fee to facilitate the sending at stage 260 of at least one application for a line of credit to one or more of the finance companies selected at stage 252. The finance company or companies contacted at stage 260, upon consideration of the application then determine at stage 265 whether a line of credit can be issued, and if so, the interest rate and credit limit associated with the line of credit.

If the determination at stage 265 results in denial of a line of credit, as shown in FIG. 2 with the line notated with a “no”, the person is so informed at stage 230. Conversely, if the determination results in at least one finance company being willing to extend a line of credit, then at stage 270 the specific finance company is selected. This selection can be by just the lessor, or the lessor can involve the person in the selection process.

Thereafter in this embodiment of the invention, at stage 275 the parties sign the rental agreement and an annual fee is obtained in connection with the establishment at stage 280 of a line of credit between a finance company and the renter. Should the renter need money to assist with payment of rent, the line of credit can be utilized at stage 285.

A second modified embodiment of the invention is disclosed in FIG. 3, which discloses yet another flow diagram for a method of financing rental housing in accordance with the invention designated generally by the numeral 300. It should be appreciated that the method begins with stage 310, at which stage a person expresses a desire to rent from a lessor or, if already a tenant, expresses a desire to be considered for a letter of credit as a method of providing financing for rental housing. This person or potential renter for purposes of the invention can be an individual, a couple, or group of individuals.

The next stage 315 has the lessor obtaining information from the person, with this information including the person's income, expenses, and debt. Subsequently, in stage 320 the lessor compares the aforesaid information with predetermined ratios that the lessor has decided to use in connection with the lessor's preliminary evaluation of the likelihood that a person will be successfully able to obtain a line of credit. The predetermined ratios can vary depending on factors including but not limited to the geographical location, the number of individuals to inhabit the residence, fixed and variable costs to be borne by the lessor, time of year, and current vacancy rates of the lessor. Upon concluding the evaluation, at stage 325 the lessor determines whether the person is a candidate for a line of credit from a finance company.

Assuming the lessor determines the income versus expense ratio and the current debt level of the potential renter or renter is such that the person will clearly not be able to obtain a line of credit, at stage 330 the lessor so informs the potential renter. Assuming the lessor still desires to rent to the person, and the renter still desires to pursue renting of the residence, at stage 335 the two parties sign a rental agreement.

Subsequent to that time, the person's financial circumstances may change, such that as shown in FIG. 3 by the line notated with a “yes” the person can go to the lessor at stage 315 to provide information on income, expenses, and debt. Otherwise, utilization of the method of this invention is over as shown by the line descending from stage 335 and notated with a “no”.

On the other hand, if the lessor determines that the person may be able to obtain a line of credit, at stage 350 the lessor so notifies them and the two parties sign the rental agreement, if the person is a potential renter. At stage 352, the lessor then determines which finance companies to contact. This determination is accomplished in part by comparing the ratios and other financial information obtained in stage 315 with the issuing requirements associated with lines of credit from some of the finance companies known to the lessor.

Having determined which finance company or companies to contact for the person, at stage 355 the lessor obtains an initial fee to facilitate the sending at stage 360 of at least one application for a line of credit to one or more of the finance companies selected at stage 352. The finance company or companies contacted at stage 360, upon consideration of the application then determine at stage 365 whether a line of credit can be issued, and if so, the interest rate and credit limit associated with the line of credit.

If the determination at stage 365 results in denial of a line of credit, as shown in FIG. 3 with the line notated with a “no”, the person is so informed at stage 330. Conversely, if the determination results in at least one finance company being willing to extend a line of credit, then at stage 370 the specific finance company is selected. This selection can be by just the lessor, or the lessor can involve the person in the selection process.

In this embodiment of the invention, instead of obtaining an annual fee, the interest rate is increased an amount agreeable to the selected finance company and the renter to obviate the payment of a separate annual fee. This can be part of stage 370 as the finance company is selected. At stage 380 the line of credit between a finance company and the renter is established. Should the renter need money to assist with payment of rent, the line of credit can be utilized at stage 385.

One advantage associated with the invention involves having the lessor, whether that is a landlord or a management company, finding a tenant who has the letter of credit discussed above to be in a preferred position to one who does not, and therefore discount the monthly rent in return for an up-front deposit of rent. This deposit could be provided through using the letter of credit, or it could be provided by other means, the key being that because of the letter of credit, the risk of having to resort to rent collection by a collection agency is minimized, thus justifying a discounted rent.

The benefits of using the line of credit include, preventing the eviction of the renter, preventing damage to the credit score of the renter, allowing the renter to use other money to pay more pressing bills, allowing the landlord to keep a rental property occupied thereby obviating the costs associated with bringing a vacant residence back into rentable condition. Allowing a prospective renter the ability to have a line of credit could make the potential renter more attractive to a lessor once the line of credit is in place.

The presence of a line of credit also eliminates the renter having to access other forms of credit they may be utilizing for other day-to-day expenses, and having to repeatedly approach the lessor with excuses as to why the rent will be late. By utilizing this invention, the rent can always be paid on time. By paying the rent on time, the renter avoids any penalty associated with the late payment of rent, and is able to keep their credit in good standing. Furthermore, by making the line of credit transferable, should the renter move to a new residence, the new lessor may be able to take advantage of the line of credit, which might be advantageous.

While the form of method herein described constitutes a preferred embodiment of the present invention and modifications thereof, it is to be understood that the invention is not limited to the precise form of the preferred embodiment of the method and that changes may be made therein without departing from the scope of the invention which is defined in the appended claims.

What is claimed is:

1. A method for financing rental housing comprising:
having the lessor obtain information from a person on income, expenses, and debt;
having the lessor conduct a preliminary evaluation on whether the person might be able to obtain a line of credit;
having the lessor notify the person that there is a possibility of the person obtaining a line of credit;
submitting a line of credit application to at least one finance company;
notifying the person of the decision of each finance company;
having each finance company select an interest rate and credit limit if the person is able to obtain a line of credit from the finance company;
having the person select a finance company; and
finalization by the person of the obtaining of a line of credit.

2. The method for financing rental housing according to claim 1 wherein said preliminary evaluation utilizes predetermined income/expense ratios.

3. The method for financing rental housing according to claim 1 which includes the step of having the lessor obtain an initial fee to cover the processing of the application by a finance company for a line of credit for the person.

4. The method for financing rental housing according to claim 1 wherein said finalization by the person of obtaining a line of credit includes paying an annual fee.

5. The method for financing rental housing according to claim 1 which includes the step of the person becoming a renter.

6. The method for financing rental housing according to claim 5 wherein said renter uses said line of credit.

7. The method for financing rental housing according to claim 1 which includes the step of increasing the interest rate owed to the selected finance company in lieu of payment of the annual fee for said line of credit.

8. The method for financing rental housing according to claim 5 which includes the step of the renter paying an access service fee when the line of credit is used.

9. The method for financing rental housing according to claim 1 wherein the line of credit is transferable to other locales.
